(19) United States
(12) Patent Application Publication
(10) Pub. No.: US 2026/0348337 A1
(43) Pub. Date: Nov. 5, 2026

(54) METHOD FOR DETERMINING ONE OR MORE CHARACTERISTIC TIMES OF A FUEL INJECTION

(71) Applicant: Robert Bosch GmbH, Stuttgart (DE)

(72) Inventors: Florian Moesenbichler, Abersee (AT); Thibault Jean Roger Henrion, Bergheim bei Salzburg (AT)

(21) Appl. No.: 19/123,610

(22) PCT Filed: Oct. 2, 2023
(86) PCT No.: PCT/EP2023/077247

§ 371 Date: Apr. 23, 2025

(30) Foreign Application Priority Data
Oct. 24, 2022 (DE) 10 2022 211 245.8

(51) Int. Cl. F02D 41/24

(52) U.S. Cl. CPC F02D 41/2467; F02D 2200/0602

(57) ABSTRACT

The present invention relates to a method for determining one or more characteristic times (NOS, NOE, NCS, NCE) of a fuel injection carried out by means of a fuel injector of an internal combustion engine, and to a computing unit and a computer program for carrying out said method. In the method according to the invention, a signal (S) is received from a sensor (36) for detecting fuel pressure changes for an injection of the fuel injector and evaluated accordingly by means of the method.

### BACKGROUND

The present invention relates to a method for determining one or more characteristic times of a fuel injection carried out by means of a fuel injector of an internal combustion engine, and to a computing unit and a computer program for carrying out said method.

Modern internal combustion engines have fuel injectors that can be used in order to selectively introduce fuel to combustion chambers. Accurate metering of fuel injection quantity is required for accurate control as well as compliance with emissions and power requirements of an internal combustion engine. However, the fuel injectors have component tolerances and are also subject to wear, resulting in tolerances in the injection quantity between different injectors and at a single injector over the course of its service life. Therefore, it is advantageous to detect characteristic times of injection events, in particular an opening and closing of a nozzle needle of the fuel injectors, as accurately as possible in order to determine the actual amount of fuel injected therefrom.

When the high-pressure fuel is introduced into the combustion chambers of the internal combustion engine, fuel injectors can be used whose nozzle needle is servo-hydraulically controlled, i.e. via a fuel pressure within a control space of the fuel injector. In this case, there is a delay between an electrical energizing and the movement of the nozzle needle of the fuel injector, such that electrical energizing variables, such as an energizing current and/or a energizing voltage, cannot be directly used in order to determine the opening and closing of the nozzle needle. Thus, such fuel injectors can use additional sensors that detect, for example, the fuel pressure within the control space of the fuel injector.

For example, DE 10 2021 203 572 A1 discloses a servo-hydraulically actuated fuel injector in which a pressure chamber is formed that is hydraulically connected to the control space of the injector. The pressure space is closed in a liquid-tight manner by a membrane, and a pressure sensor is arranged above the membrane and configured so as to measure the pressure in the pressure chamber.

### SUMMARY

The invention proposes a method for determining one or more characteristic times of a fuel injection carried out by means of a fuel injector of an internal combustion engine, and to a computing unit and a computer program for carrying out said method having the features of the disclosure are proposed. Advantageous embodiments are the subject of the following description.

As fuel injectors, servo fuel injectors and fuel injectors with a switching valve are in question here, because a direct determination of the characteristic times from their electrical control variables is not possible. In particular, the method is suitable for a fuel injector in accordance with DE 10 2021 203 572 A1.

A sensor for detecting fuel pressure changes is arranged in the fuel injector. The sensor is preferably arranged in the fuel injector such that it can detect a pressure in a control space of the fuel injector. The sensor can preferably be a piezoelectric sensor, whose signal is sent to a computing unit, which can preferably be the engine control unit. To carry out the fuel injection, the fuel injector receives an energizing signal comprising a start of energizing (SE) and an end of energizing (EOE). In particular, the fuel injector can receive the energizing signal from a computing unit, which can preferably be the engine control unit.

Characteristic fuel injection times are understood to mean times during the opening and closing operation of the fuel injector (or its nozzle needle). In particular, a needle opening start, when the nozzle needle moves from a nozzle needle seat (NOS), a needle opening end, when the nozzle needle reaches an upper nozzle needle stop (NOE), a needle closing start, when the nozzle needle moves away from the upper nozzle needle stop (NCS), and a needle closing end, when the nozzle needle arrives back at the nozzle needle seat (NCE), are characteristic times.

An analysis of the sensor signal with regard to one or more of the characteristic times mentioned above allows a direct conclusion to be drawn about the actual behavior of the nozzle needle and thus the amount of fuel actually introduced into the combustion space of the internal combustion engine. The analysis can preferably be carried out in the entire operating range of the engine, i.e. at different fuel pressures and energizing durations of the fuel injector, under different external boundary conditions (signal interferences, variable transition resistances).

Specifically, a signal is received from the fuel pressure change detection sensor for an injection of the fuel injector. In other words, a signal is received from the sensor representing/reflecting a pressure change in the fuel injector, preferably in the control space of the fuel injector, for a period of time of an injection (control space pressure signal).

The received signal is subsequently filtered with a first filter and a second filter, wherein the second filter has a different filter characteristic (in particular a larger filter width) than the first filter. This means that the signal filtered with the second filter (second filtered signal) is filtered differently (especially more strongly) than the signal filtered with the first filter (first filtered signal). In particular, the received signal is filtered at a predetermined time interval from a start of energizing to a predetermined time after the start of energizing with the first and second filters.

Subsequently, a difference signal is formed by subtracting the first filtered signal from the second filtered signal. Furthermore, at least one characteristic time is determined in the received signal and/or the second filtered signal and/or the difference signal.

A first characteristic time is determined based on a local maximum of the difference signal in one exemplary embodiment. In particular, the first characteristic time can be the needle opening start at which the nozzle needle moves out of the nozzle needle seat.

In one exemplary embodiment, a second characteristic time is determined based on a local maximum of the first derivative of the second filtered signal. In this case, the second characteristic time can preferably be the needle closing end, at which the nozzle needle arrives back at the nozzle needle seat.

In one exemplary embodiment, a third characteristic time is determined based on a local maximum of the received signal. Preferably, the third characteristic time can be the needle closing start, at which the nozzle needle again moves away from the upper nozzle needle stop.

In one exemplary embodiment, a fourth characteristic time is determined based on a minimum of the second derivative of the received signal. Preferably, the fourth characteristic time can be the needle opening end, at which the nozzle needle reaches the upper nozzle needle stop.

For example, based on the four characteristic times described above, an injection rate of the fuel injection carried out can be determined, from which, in turn, an amount of fuel introduced into the internal combustion engine can be determined. This can be compared to a piloted amount of fuel, and the difference between the two values can be used in order to control the amount of fuel injection. Thus, by means of the determined characteristic times, the accuracy of the fuel metering can be increased at all operating points of the internal combustion engine and under different external boundary conditions.

According to one embodiment, in order to determine the first characteristic time, preferably all local maxima of the difference signal exceeding both a first threshold value and a second threshold value are determined, starting from a first predetermined time, and a first determined local maximum of the difference signal is determined as the first characteristic time. In other words, the first characteristic time, in particular the needle opening start, can be determined from a local maximum of the difference signal that occurs temporally first after the first predetermined time and exceeds both a first and a second threshold value.

The first predetermined time can advantageously be a time starting from which the first characteristic time can occur physically. In the preferred case that the first characteristic time is the needle opening start, it can occur with a preferably employed servo injector only after a delay of time after the start of energizing. For example, this delay can be measured at one or more fuel injectors on the test bench, and the predetermined time can be determined based on the measured time delay. Particularly preferably, the first predetermined time can be set at approximately 300 μs after the fuel injector has started energizing

According to one embodiment, it is determined that there is no characteristic first time, in particular no needle opening start, when the first determined local maximum of the difference signal has the highest value of all determined local maxima. In this case, it can in particular also be determined that the nozzle needle will also no longer be opened. The maxima in the difference signal result from several effects always visible in the signal, wherein these effects generally always generate a higher maximum in the difference signal than the needle opening start. Thus, if the first maximum is already the highest, it can be assumed that needle opening no longer takes place.

According to one embodiment, threshold values are determined relative to a reference amplitude determined in the respective signal. In particular, the reference amplitude can be a signal amplitude of the first filtered signal that occurs temporally as the first negative signal amplitude after the start of energizing of the fuel injector. To determine the reference amplitude as accurately as possible, an output level of the first filtered signal (e.g. a zero line of the signal) can be determined, for example by averaging a predetermined number of signal values prior to the start of energizing of the fuel injector. In addition, an amount of the first negative signal amplitude can be determined based on a first minimum of the first filtered signal, for example by averaging a predetermined number of signal values in a predetermined range about a minimum value of the first filtered signal which occurs as the first minimum value after the start of energizing of the fuel injector. Preferably, all signal values for determining the minimum of the first filtered signal are at a time interval between the start of energizing of the fuel injector and a second predetermined time. Particularly preferably, the second predetermined time can be 0.8 ms after the start of energizing of the fuel injector. The reference amplitude can then be determined by forming a difference between the determined starting level and the determined first minimum of the first filtered signal.

According to one embodiment, the first threshold value is formed from a predetermined first value and the reference amplitude. The first predetermined value can preferably be set as a function of the system pressure (rail pressure). In particular, the predetermined first value can be a first predetermined factor for a minimum level of the local maxima in the difference signal by which the reference amplitude can be multiplied. Thus, the number of determined local maxima of the difference signal is limited to those whose level exceeds a minimum level in relation to the reference amplitude.

Analogously to the first threshold value, the second threshold value can also be formed from a predetermined second value and the reference amplitude. The second predetermined value can also advantageously be determined as a function of the system pressure (rail pressure). In particular, the predetermined second value can be a second predetermined factor for a minimum prominence of the local maxima in the difference signal by which the reference amplitude can be multiplied. Thus, the number of local maxima of the difference signal can be additionally limited to those whose prominence exceeds a minimum prominence in relation to the reference amplitude.

A prominence of a local maximum is understood to mean a value that indicates how much the local maximum stands out in relation to its level and position compared to other local maxima. To determine the prominence of a local maximum in the difference signal, a horizontal line can be drawn from the local maximum to the left and to the right. Where the horizontal line intersects a curve of the difference signal left and right (e.g. at a further local maximum or at the beginning or end of the signal), outer end points of a left and right intervals can be marked. A vertical distance between a greatest negative signal amplitude within the two intervals and the local maximum can then be determined as the prominence of the local maximum.

According to one embodiment, to determine the second characteristic time, all local maxima of the first derivative of the second filtered signal exceeding a third threshold value are determined, starting from the end of energizing of the fuel injector, and a final determined local maximum of the first derivative of the second filtered signal is determined as the second characteristic time. In other words, the second characteristic time, in particular the needle closing end, can be determined from a local maximum of the first derivative of the second filtered signal, which occurs temporally as the final maximum in the relevant signal and exceeds a third threshold value.

According to one embodiment, the third threshold value is formed from a predetermined third value and the reference amplitude. The third predetermined value can also advantageously be determined as a function of the system pressure (rail pressure). In particular, the predetermined third value can be a third predetermined factor for a minimum prominence of the local maxima in the first derivative of the second filtered signal, by which the reference amplitude can be multiplied. Thus, the number of local maxima of the first derivative of the second filtered signal can be limited to those whose prominence exceeds a minimum prominence in relation to the reference amplitude.

According to one embodiment, the third characteristic time is determined as a global maximum of the first filtered signal from the end of energizing of the fuel injector up to the second characteristic time. In other words, the third characteristic time, in particular the needle closing start, can be determined from a global maximum of the first filtered signal, which lies temporally between the end of energizing of the fuel injector and the second characteristic time, in particular the needle closing end.

According to one embodiment, an absolute minimum of the second derivative of the first filtered signal can be determined as the fourth characteristic time, in particular as the needle opening end, when an absolute minimum of the first derivative of the first filtered signal lies before the third characteristic time, in particular before the needle closing end. In that case, the nozzle needle is opened to the point where it reaches the nozzle needle stop.

The absolute minimum of the second derivative corresponds to the maximum negative curvature of the first filtered signal and thus the fourth characteristic time sought, in particular the needle opening end.

If the absolute minimum of the first derivative of the received signal lies after the third characteristic time, in particular after the needle closing start, it can be determined that there is no fourth characteristic time, in particular no needle opening end. In this case, the nozzle needle is operated in the ballistic range, i.e. the nozzle needle is not opened enough to reach the upper nozzle needle stop.

According to one embodiment, the fuel injector is energized, in particular in subsequent fuel injections, taking into account the one or more determined characteristic times. This means that, for example, due to an actual fuel quantity determined from the characteristic times, the start of energizing, end of energizing, and/or duration of a subsequent fuel injection can be adjusted in order to inject the desired/required fuel quantity at the present operating point. This allows for an improvement in the accuracy of fuel metering at all operating points of the internal combustion engine under different external boundary conditions.

A computing unit according to the invention, e.g. a control device of an internal combustion engine, which can preferably be an engine control unit, is configured, in particular in relation to programming, so as to carry out a method according to the invention.

The implementation of a method according to the invention in the form of a computer program or computer program product comprising program code for carrying out all method steps is advantageous as well, because the associated costs are very low, in particular if an executing control device is also used for other tasks and is therefore already available. Lastly, a machine-readable storage medium is provided, on which a computer program as described above is stored. Suitable storage media or data carriers for providing the computer program are in particular magnetic, optical and electrical memories, such as hard drives, flash memories, EEPROMs, DVDs, etc. Downloading a program via computer networks (Internet, intranet, etc.) is possible, too. Such a download can be wired or cabled or wireless (e.g., via a WLAN, a 3G, 4G, 5G, or 6G connection, etc.).

Further advantages and embodiments of the invention will emerge from the description of the accompanying drawings.

The invention is illustrated schematically in the drawings on the basis of exemplary embodiments and is described in the following with reference to said drawings.

### BRIEF DESCRIPTION OF THE DRAWINGS

FIG. 1a schematically shows a longitudinal section of a fuel injector on which the method according to the invention can be used.

FIG. 1b schematically shows a current curve, a nozzle needle stroke curve, an injection rate, and a control space pressure signal of a fuel injector according to FIG. 1a.

FIG. 2 schematically shows an excerpt of the control space pressure signal from FIG. 1b as well as two control space pressure signals filtered with a first and a second filter, respectively.

FIG. 3 schematically shows a difference signal formed from the two filtered control space pressure signals shown in FIG. 2.

FIG. 4 schematically shows the first filtered control space pressure signal, the difference signal, and a first threshold value above which local maxima of the difference signal are considered in order to determine the needle opening start.

FIG. 5 schematically shows the current curve of the energizing as well as the first filtered control space pressure signal, which has a reference amplitude, which can be used in order to determine, for example, the second threshold value shown in FIG. 4.

FIG. 6 schematically shows the current curve of the fuel injector, as well as a first derivative of the second filtered control space pressure signal and a third threshold value above which local maxima of the first derivative of the second filtered control space pressure signal are considered in order to determine the needle closing end.

FIG. 7 schematically shows the current curve of the fuel injector and the control space pressure signal as well as a time interval in which a local maximum of the control space pressure signal is determined as the needle closing start.

FIG. 8 schematically shows the control space pressure signal as well as its first and second derivatives for determining the needle opening end.

### DETAILED DESCRIPTION

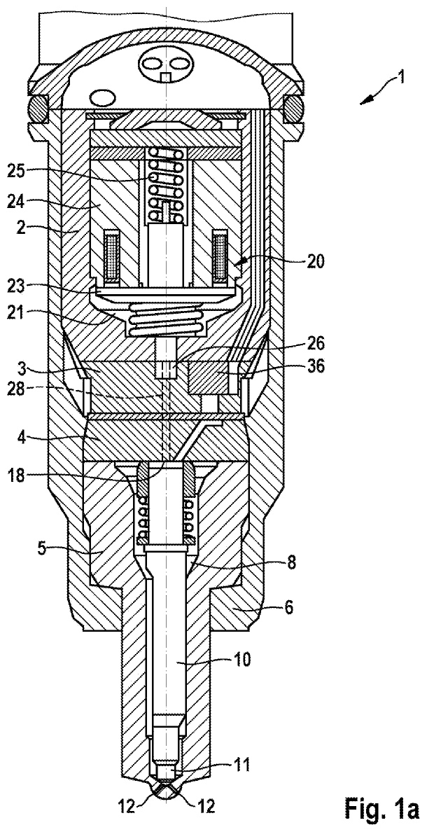

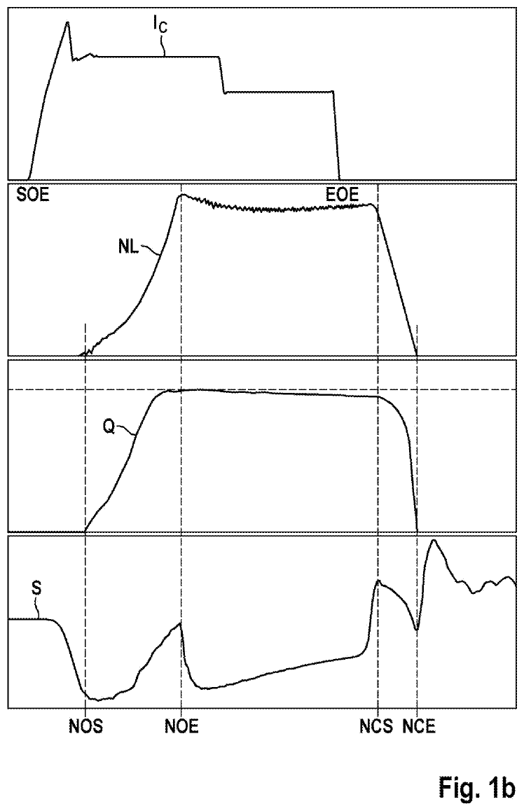

FIG. 1a schematically shows a longitudinal section of a fuel injector on which the method according to the invention can be used. Only the essential areas of the fuel injector are shown.

The fuel injector comprises a housing 1 having a valve body 2, a valve plate 3, a throttle plate 4 and a nozzle body 5 which are positioned adjacent to one another in this order. A pressure space 8 is formed in the nozzle body 5, which can be filled with fuel at high pressures. The fuel is directed through a high-pressure bore (not shown) through the valve body 2, the valve plate 3, and the throttle plate 4 into the pressure space 8. In the pressure space 8, a nozzle needle 10 is arranged in a longitudinally displaceable manner, which cooperates with a nozzle needle seat 11, which is formed at the lower end of the pressure space 8.

At the lower end of the nozzle body 5, a plurality of injection holes 12 are formed which, in the installed state of the fuel injector, open into a combustion space of an internal combustion engine. When the nozzle needle 10 is attached to the nozzle needle seat 11, it closes the injection holes 12 against the pressure space 8. The nozzle needle 10 also limits a control space 18 with its front face facing away from the nozzle needle seat 11. The control space 18 is connected to the pressure space 8 via an inlet choke (not shown in further detail), so that the same pressure is given in the control space 18 with the nozzle needle 10 closed as in the pressure space 8.

A switching valve 20 is arranged in a low pressure space 21 formed in the valve body 2 and comprises a solenoid armature 23, an electromagnet 24, an armature spring 25, and a switching valve seat 26. The solenoid armature 23 is arranged longitudinally in the low pressure space 21 and cooperates with the switching valve seat 26 for opening and closing a drain bore 28 connecting the control space 18 to the low pressure space 21. The low pressure space is connected to a low pressure return line via a conduit (not shown).

By means of a pressure sensor 36, which is arranged in the example shown in the valve plate 3, but can also be seated elsewhere, for example in the valve body 2, the pressure in the control space 18 can be determined. For example, the pressure sensor 36 can be configured as a piezoelectric sensor and can be connected to a controller (not shown) via an electrical connection line, which can preferably be the engine control unit.

The opening and closing of the nozzle needle 10 of the fuel injector, and thus the fuel injection, is controlled by means of the switching valve 20. When the solenoid 24 of the switching valve 20 is energized, it exerts an attractive force on the solenoid armature 23 and moves it out of the switching valve seat 26 counter to a force of the armature spring 25. If the solenoid armature 23 releases the drain bore 28, fuel flows from the control space 18 into the low pressure space 21, thereby decreasing the pressure in the control space 18. The nozzle needle 10 is lifted off the nozzle needle seat 11 due to the now higher pressure in the pressure space 8 and releases the injection holes 12. When the energizing of the electromagnet 24 ceases, the armature spring 25 pushes the magnetic armature 23 back to its closed position. The fuel pressure in the control space 18 then rises back to the level of the pressure space 8 and pushes the nozzle needle 10 back into its closed position.

The pressure in the control space 18 has a characteristic curve during the above-described fuel injection process and is illustrated by a control space pressure signal S of the pressure sensor 36, schematically shown in FIG. 1b. The characteristic times of a needle opening start NOS, a needle opening end NOE, a needle closing start NCS, and a needle closing end NCE are marked in the signal curve S.

Also schematically shown in FIG. 1b is a current curve I_{C} through the electromagnet 24, with a start of energizing SOE and an end of energizing EOE, a nozzle needle stroke curve NL of the nozzle needle 10, and an injection rate Q of the fuel injector according to FIG. 1a.

With the switching valve 20 unactuated or the solenoid 24 unenergized, the pressure in the control space 18 corresponds to the pressure in the pressure space 8. When the switching valve 20 is actuated or the solenoid 24 is energized, the solenoid armature 23 opens the drain bore 28, and the pressure in the control space 18 drops as more fuel flows through the drain bore 28 out of the control space 18 than flows afterwards through the inlet choke (see the signals current curve _{C}, nozzle needle stroke NL, and control space pressure S after the start of energizing SOE in FIG. 1b). The nozzle needle 10 then moves out of the nozzle needle seat 11 in the direction of opening. As long as the nozzle needle 10 is in motion, the pressure in the control space 18 results from a balance of forces on the nozzle needle 10. This means that the pressure in the control space 18 increases as long as the nozzle needle 10 moves upwards (see the signals nozzle needle stroke NL and control space pressure S during the time interval from NOS to NOE in FIG. 1b). When the nozzle needle 10 reaches its maximum stroke and abuts an upper nozzle needle stop, a pressure drop in the control space 18 is adjusted according to the flows through the drain bore 28 and the inlet choke (see the signal of control space pressure S directly after the time NOE in FIG. 1b). When the control of the switching valve 20 is switched off, the pressure in the control space 18 increases, until there is a balance of forces on the nozzle needle 10 and it moves again towards the nozzle needle seat 11 (see the signal of the control space pressure S after EOE shortly before NCS in FIG. 1b). Due to the closing movement of the nozzle needle 10, the pressure in the control space 18 subsequently decreases again, until the nozzle needle 10 reaches the nozzle needle seat 11 (see the signals nozzle needle stroke NL and control space pressure S during the time interval between NCS and NCE in FIG. 1b). When the nozzle needle 10 then strikes in the nozzle needle seat 11, the pressure in the control space 18 ultimately rises again to the pressure in the pressure space 8 (see the signals nozzle needle stroke NL and control space pressure S at the time NCE).

The described connections between the pressure in the control space 18 and the movements of the switching valve 20 and the nozzle needle 10 also apply in the ballistic operation of the nozzle needle 10, i.e. when the energizing I_{C} of the electromagnet 24 is so short that the nozzle needle 11 does not reach the nozzle needle stop.

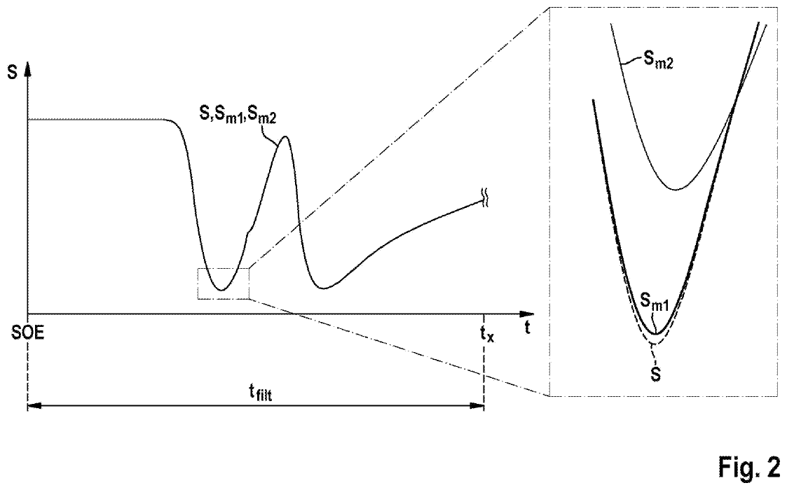

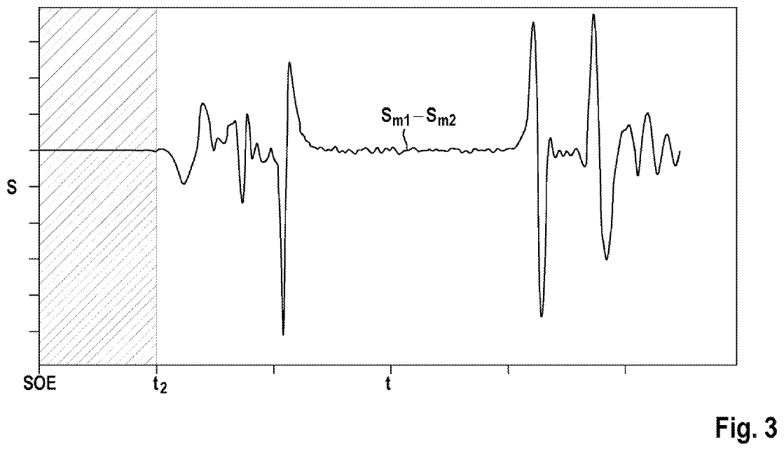

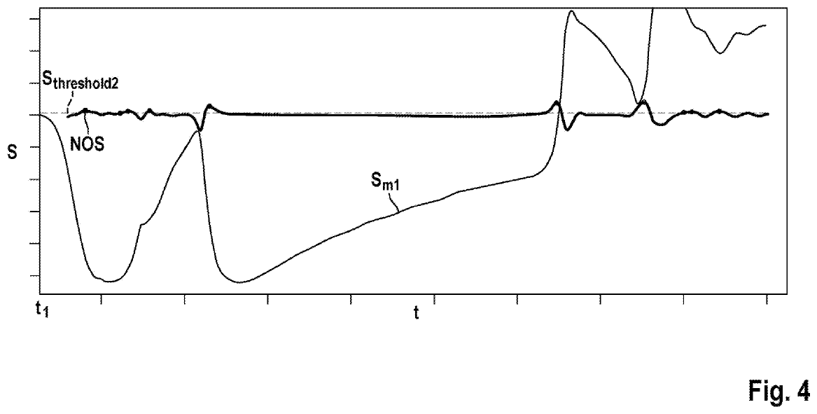

FIG. 2 schematically shows an excerpt of the control space pressure signal S from FIG. 1b in a time interval t_{filt} extending from a start of energizing SOE of the fuel injector up to a predetermined time tₓ and in which the filtering of the control space pressure signal S occurs with a first and second filter. The filtered control space pressure signals Sₘ₁ and Sₘ₂ (first and second filtered (control space pressure) signal) resulting from the filtering with the first and second filters are also shown in FIG. 2. The filters used can comprise moving average filters whose filter width is preferably dependent on a sampling frequency of the received control space pressure signal and/or other filters. Based on the enlarged excerpt of the signal curves S, Sₘ₁, and Sₘ₂ in the area of a first negative signal amplitude of the control space pressure signal S after the start of energizing SOE, it is clear that the second filter has a greater filter width than the first filter. In other words, the second filtered control space pressure signal Sₘ₂ is more strongly filtered/averaged than the first filtered control space pressure signal Sₘ₁, whereby its first negative signal amplitude has a lower level than that of the first control space pressure signal Sₘ₁. The first negative signal amplitude of the first filtered control space pressure signal Sₘ₁ differs only marginally from the received control space pressure signal S. Based on the difference in the signal curve of the two filtered signals Sₘ₁ and Sₘ₂ in the area of the first negative signal amplitude of the control space pressure signal S after the start of energizing SOE, a first characteristic time, in particular a needle opening start NOS, is determined, as will be explained in further detail in connection with FIGS. 3 and 4.

FIG. 3 schematically shows a difference signal Sₘ₂−Sₘ₁ plotted over a time axis t formed from the two filtered control space pressure signals Sₘ₁ and Sₘ₂. By contrast to FIG. 2, however, the difference signal Sₘ₂−Sₘ₁ shown in FIG. 3 is based on a control pressure signal curve that spans the entire fuel injection. To determine the first characteristic time, in particular to determine the needle opening start NOS, first all signal values of the difference signal Sₘ₂−Sₘ₁ that lie before a first predetermined time t₁ after the start of energizing SOE are removed.

The first predetermined time t₁ can advantageously be a time from which a needle opening start NOS can generally occur. With a preferably employed servo injector, it can occur only after a delay after the start of energizing SOE. For example, this delay can be measured at one or more fuel injectors on the test bench, and the predetermined time can be determined based on the measured time delay.

FIG. 4 schematically shows the first filtered control space pressure signal Sₘ₁, the difference signal Sₘ₂−Sₘ₁, and a first threshold value S_{threshold1} above which local maxima of the difference signal Sₘ₂−Sₘ₁ are considered in order to determine the needle opening start NOS. All signals are plotted over a time axis t.

To determine the needle opening start NOS, preferably all local maxima of the difference signal Sₘ₂−Sₘ₁, which exceed both a first threshold value and the second threshold value S_{threshold2}, are determined from the first predetermined time t₁. The first threshold value preferably represents a minimum level, and the second threshold value S_{threshold2} represents a minimum prominence, which must exceed a local maximum of the difference signal Sₘ₂−Sₘ₁ in order to be deemed relevant. For the sake of clarity, only the first threshold value S_{threshold1} is shown in FIG. 4, and all local maxima of the difference signal Sₘ₂−Sₘ₁ starting from the time t₁ are marked with a circle. Based on the local maxima determined in this way, the needle opening start NOS can be determined as the time of the first local maximum after the time t₁.

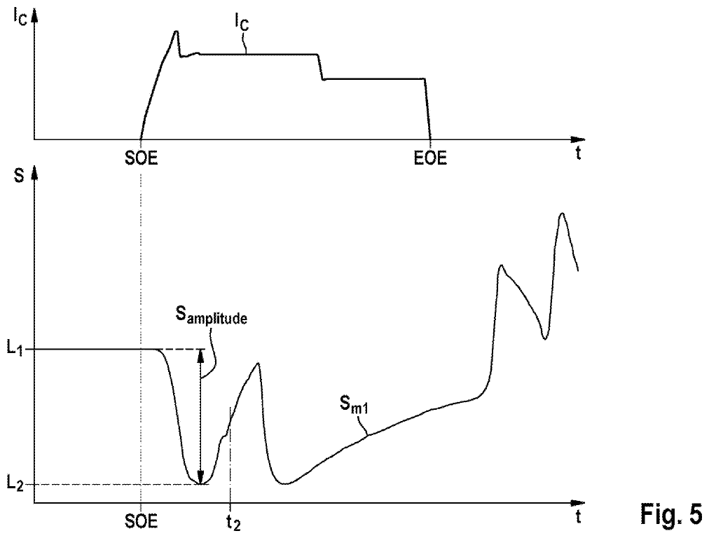

FIG. 5 schematically shows the current curve I_{C} of the fuel injector as well as the first filtered control space pressure signal Sₘ₁, which has a reference amplitude S_{amplitude} that can be used in order to determine, for example, the second threshold value S_{threshold2} shown in FIG. 4. In particular, the shown reference amplitude S_{amplitude} can be used as the basis for all threshold values to be determined as part of the determination of the one or more characteristic times. The signals shown are respectively shown over a time axis t.

According to FIG. 5, the reference S_{amplitude} is determined based on a signal amplitude of the first filtered signal Sₘ₁ which occurs temporally as the first negative signal amplitude after the start of energizing SOE of the fuel injector. The start of energizing SOE is characterized in FIG. 5 by the current curve I_{C} of the fuel injector. To determine the reference amplitude S_{amplitude} as accurately as possible, an output level L₁ of the first filtered signal (e.g. a zero line of the signal Sₘ₁) can be determined, for example by averaging a predetermined number of signal values prior to the start of energizing SOE of the fuel injector. In addition, an amount of the first negative signal amplitude can be determined based on a first minimum L₂ of the first filtered signal Sₘ₁, for example by averaging a predetermined number of signal values in a predetermined range about a minimum value of the first filtered signal Sₘ₁ which occurs as the first minimum value after the start of energizing SOE of the fuel injector. Preferably, all signal values for determining the minimum L₂ of the first filtered signal Sₘ₁ are at a time interval between the start of energizing SOE of the fuel injector and a second predetermined time t₂. The reference amplitude S_{amplitude} can then be determined by forming a difference between the determined starting level L₁ and the determined first minimum L₂ of the first filtered signal Sₘ₁.

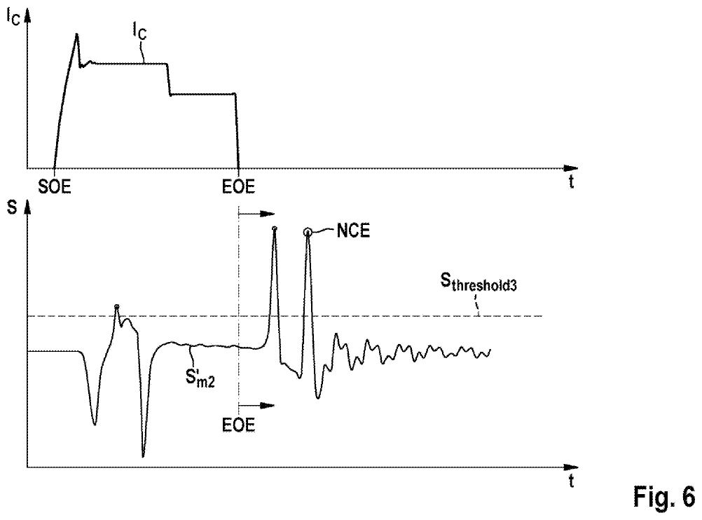

FIG. 6 schematically shows the current curve _{IC} of the fuel injector as well as a first derivative S′ₘ₂ of the second filtered control space pressure signal Sₘ₂ and a third threshold value S_{threshold3} above which local maxima of the first derivative S′ₘ₂ for determining the needle closing end NCE are taken into account. The signals shown are shown respectively over a time axis t.

According to FIG. 6, to determine the needle closing end NCE, all local maxima of the first derivative S′ₘ₂ of the second filtered control space pressure signal Sₘ₂ that exceed a third threshold S_{threshold3} are determined. These are each marked with a circle. Because the needle closing end NCE must occur after the end of energizing EOE of the fuel injector, only the local maxima determined after the end of energizing EOE are relevant for the time sought. The end of energizing EOE is labeled in FIG. 6 based on the current curve I_{c} of the fuel injector. The needle closing end NCE is then determined as the last determined local maximum of the first derivative S′ₘ₂ of the second filtered control space pressure signal Sₘ₂. In other words, the needle closing end NCE can be determined from a local maximum of the first derivative S′ₘ₂ of the second filtered control space pressure signal Sₘ₂ that occurs temporally as the last maximum in the relevant signal and exceeds a third threshold S_{threshold3}. The third threshold value preferably represents a minimum prominence that must exceed a local maximum of the first derivative S′ₘ₂ of the second filtered signal Sₘ₂ in order to be deemed relevant.

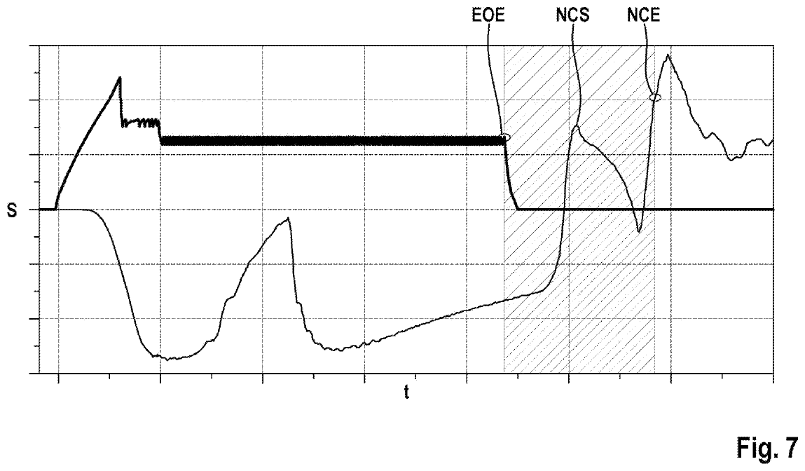

FIG. 7 schematically shows the current curve I_{C} of the fuel injector and the control space pressure signal S as well as a time interval in which a local maximum of the control space pressure signal S is determined as the needle closing start NCS. The time interval shown (hatched) extends from the end of energizing EOE of the fuel injector, which is once again specified by the current curve I_{C}, up to the needle closing end NCE, which has already been determined according to FIG. 6. At this time interval, the needle closing start NCS can be simply determined based on the shown global maximum of the received control space pressure signal S. In other words, the needle closing start NCS can be determined based on a global maximum of the received control space pressure signal S, which lies temporally between the end of energizing EOE of the fuel injector and the needle closing end NCE.

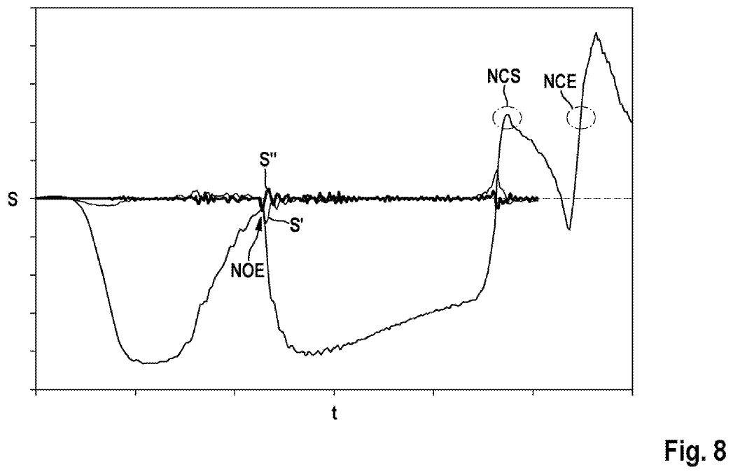

FIG. 8 schematically shows the received control space pressure signal S as well as its first and second derivative S′, S″ for determining the needle opening end NOE. According to FIG. 8, an absolute minimum of the second derivative S″ of the received control space pressure signal S can be determined as the needle opening end NOE when an absolute minimum of the first derivative S′ of the received control space pressure signal lies before the needle closing start NCS. In that case, the nozzle needle 10 is opened to the point where it reaches the nozzle needle stop. The absolute minimum of the second derivative S″ then corresponds to the maximum negative curvature of the received control space pressure signal S and thus the sought needle opening end NOE. However, when the absolute minimum of the first derivative S′ of the received control space pressure signal S lies after the needle closing start NCS (not shown), it can be determined that there is no needle opening end NOE. In this case, the nozzle needle 10 is operated in the ballistic range, i.e. the nozzle needle 10 is not opened enough to reach the upper nozzle needle stop.

In summary, the method according to the invention allows for a determination of the characteristic times during a fuel injection, based on which the fuel mass actually injected can be determined. This can be compared to a piloted amount of fuel, and the difference between the two values can be used in order to control the amount of fuel injection. Thus, by means of the determined characteristic times, the accuracy of the fuel metering can be increased at all operating points of the internal combustion engine and under different external boundary conditions.

Furthermore, knowledge of the characteristic times allows for a stable positioning of the injection start and/or injection duration over the lifetime of the injector and an expanded possibility of diagnosis in the event of implausible changes of one or more characteristic times in operation.

1. A method for determining one or more characteristic times (NOS, NOE, NCS, NCE) of a fuel injection carried out by means of a fuel injector of an internal combustion engine,
wherein, to carry out the fuel injection, the fuel injector receives an energizing signal having a start of energizing (SE) and an end of energizing (EOE), and a sensor (36) for detecting fuel pressure changes is arranged in the fuel injector,
comprising the following steps:
receiving a signal (S) from the sensor (36) for detecting fuel pressure changes for an injection of the fuel injector;
filtering the received signal (S) with a first filter and a second filter, wherein the second filter has a different filter characteristic than the first filter;
forming a difference signal (Sₘ₂−Sₘ₁) by subtracting the first filtered signal (Sₘ₁) from the second filtered signal (Sₘ₂);
determining at least one characteristic time (NOS, NCE, NCS, NOE) from the received signal (S) and/or the second filtered signal (Sₘ₂) and/or the difference signal (Sₘ₂−Sₘ₁).

2. The method according to claim 1, wherein the determination of at least one characteristic time (NOS, NCE, NCS, NOE) from the received signal (S) and/or the second filtered signal (Sₘ₂) and/or the difference signal (Sₘ₂−Sₘ₁) comprises the following:
a) determining a first characteristic time (NOS) based on a local maximum of the difference signal (Sₘ₂−Sₘ₁); forming a first derivative (S′ₘ₂) of the second filtered signal (Sₘ₂);
and/or
b) determining a second characteristic time (NCE) based on a local maximum of the first derivative (S′ₘ₂) of the second filtered signal (Sₘ₂);
and/or
c) determining a third characteristic time (NCS) based on a local maximum of the received signal (S);
and/or
d) forming a second derivative (S″) of the received signal (S); determining a fourth characteristic time (NOC) based on a minimum of the second derivative (S″) of the received signal (S).

3. The method according to claim 2, wherein
to determine the first characteristic time (NOS), all local maxima of the difference signal (Sₘ₂−Sₘ₁) exceeding both a first threshold value and a second threshold value (S_{threshold2}) are determined starting from a first predetermined time (t₁), and
a first determined local maximum of the difference signal (Sₘ₂−Sₘ₁) is determined as the first characteristic time (NOS).

4. The method according to claim 3, wherein it is determined that there is no characteristic first time (NOS) when the first determined local maximum of the difference signal (Sₘ₂−Sₘ₁) has the highest value of all determined local maxima.

5. The method according to claim 3, wherein
the first threshold value is formed from a predetermined first value and a reference amplitude (S_{amplitude}), and
the second threshold value (S_{threshold2}) is formed from a predetermined second value and the reference amplitude (S_{amplitude}).

6. The method according to claim 2, wherein
to determine the second characteristic time (NCE), all local maxima of the first derivative (S′ₘ₂) of the second filtered signal (Sₘ₂) exceeding a third threshold value (S_{threshold3}) are determined starting from the end of energizing (EOE) of the fuel injector, and
a final determined local maximum of the first derivative (S′ₘ₂) of the second filtered signal (Sₘ₂) is determined as the second characteristic time (NCE).

7. The method according to claim 6, wherein
the third threshold value (S_{threshold3}) is formed from a predetermined third value and the reference amplitude (S_{amplitude}).

8. The method according to claim 2, wherein
a global maximum of the received signal (S) is determined starting from the end of energizing (EOE) of the fuel injector up to the second characteristic time (NCE) as the third characteristic time (NCS).

9. The method according to claim 2, wherein
an absolute minimum of the second derivative (S″) of the received signal (S) is determined as the fourth characteristic time (NOE) when an absolute minimum of the first derivative (S′) of the received signal (S) lies before the third characteristic time (NCS), and
it is determined that there is no fourth characteristic time (NOE) when the absolute minimum of the first derivative (S′) of the received signal lies after the third characteristic time (NCS).

10. The method according to claim 1, claims, wherein the fuel injector is energized, taking into account the at least one determined characteristic time (NOS, NOC, NCS, NCE).

11. A computing unit configured so as to determine one or more characteristic times (NOS, NOE, NCS, NCE) of a fuel injection carried out by means of a fuel injector of an internal combustion engine and a sensor (36) for detecting fuel pressure changes, and to control the fuel injection by:
receiving a signal (S) from the sensor (36) for detecting fuel pressure changes for an injection of the fuel injector;
filtering the received signal (S) with a first filter and a second filter, wherein the second filter has a different filter characteristic than the first filter;
forming a difference signal (Sₘ₂−Sₘ₁) by subtracting the first filtered signal (Sₘ₁) from the second filtered signal (Sₘ₂);
determining at least one characteristic time (NOS, NCE, NCS, NOE) from the received signal (S) and/or the second filtered signal (Sₘ₂) and/or the difference signal (Sₘ₂−Sₘ₁) and
sending the fuel injector an energizing signal having a start of energizing (SE) and an end of energizing of

12. (canceled)

13. A non-transitory, machine-readable storage medium comprising instructions that when executed by a computer cause the computer to determine one or more characteristic times (NOS, NOE, NCS, NCE) of a fuel injection carried out by means of a fuel injector of an internal combustion engine and a sensor (36) for detecting fuel pressure changes, and to control the fuel injection by:
receiving a signal (S) from the sensor (36) for detecting fuel pressure changes for an injection of the fuel injector;
filtering the received signal (S) with a first filter and a second filter, wherein the second filter has a different filter characteristic than the first filter;
forming a difference signal (Sₘ₂−Sₘ₁) by subtracting the first filtered signal (Sₘ₁) from the second filtered signal (Sₘ₂);
determining at least one characteristic time (NOS, NCE, NCS, NOE) from the received signal (S) and/or the second filtered signal (Sₘ₂) and/or the difference signal (Sₘ₂−Sₘ₁); and
sending the fuel injector an energizing signal having a start of energizing (SE) and an end of energizing (EOE).
